(19) United States
(12) Patent Application Publication
(10) Pub. No.: US 2022/0324488 A1
(43) Pub. Date: Oct. 13, 2022

(54) INFORMATION PROCESSING SYSTEM, INFORMATION PROCESSING APPARATUS, AND INFORMATION PROCESSING METHOD

(71) Applicant: SONY GROUP CORPORATION, TOKYO (JP)

(72) Inventors: TAICHI YUKI, TOKYO (JP); TATSUYA ISHIKAWA, TOKYO (JP); RYOTA KIMURA, TOKYO (JP)

(21) Appl. No.: 17/765,829

(22) PCT Filed: Sep. 1, 2020
(86) PCT No.: PCT/JP2020/037586

§ 371 Date: Mar. 31, 2022

(30) Foreign Application Priority Data
Oct. 11, 2019 (JP) 2019-187757

(51) Int. Cl. B60W 60/00; H04W 4/44; H04W 4/38; H04W 4/02

(52) U.S. Cl. CPC B60W 60/0016; H04W 4/44; H04W 4/38; H04W 4/023; B60W 2556/45; B60W 2556/50

(57) ABSTRACT

An information comparison unit (53) (comparison unit) of an RSU (10a) (information processing apparatus) compares first data (D1) related to a positional relationship between a vehicle (V) and an object existing around the vehicle, the first data (D1) being obtained from a first sensor unit (59) that is mounted on the vehicle (V) by a vehicle information reception unit (50) (first acquisition unit) and that obtains information related to travel control of the vehicle (V), with second data (D2) related to a positional relationship regarding objects existing on a road (R), the second data (D2) being obtained by an object detection unit (52) (second acquisition unit). Subsequently a correction information generation unit (54) generates correction data (Dc) to be used for correcting an output of the first sensor unit (59) based on a comparison result of the information comparison unit (53), and then the information transmission unit (56) (transmission unit) transmits the correction data (Dc) to the vehicle (V).

### FIELD

The present disclosure relates to an information processing system, an information processing apparatus, and an information processing method, and more particularly relates to an information processing system, an information processing apparatus, and an information processing method capable of continuing travel control even in the case of accuracy deterioration of an in-vehicle sensor related to travel control of the vehicle.

### BACKGROUND

Conventionally, there has been proposed a method of performing group control of traveling vehicles using vehicle-to-vehicle communication or road-to-vehicle communication (for example, Patent Literature 1).

### CITATION LIST

### Patent Literature

Patent Literature 1: JP 3520691 B2

### SUMMARY

### Technical Problem

However, in the proposed control method, accuracy of various in-vehicle sensors for performing travel control is confirmed by comparing recognition results obtained by the sensors with each other using vehicle-to-vehicle communication on the premise that the sensors are all under normal operation. Therefore, when the accuracy of the sensor of the vehicle deteriorates, accurate travel control cannot be performed.

The present disclosure relates to an information processing system, an information processing apparatus, and an information processing method capable of continuing vehicle control even in the case of accuracy deterioration of sensors mounted on a vehicle.

### Solution to Problem

To solve the problems described above, an information processing system according to an embodiment of the present disclosure includes: a first acquisition unit that acquires first data related to a positional relationship between a vehicle and an object existing around the vehicle, the first data being obtained by a first sensor unit that is mounted on the vehicle and obtains information related to travel control of the vehicle, the first data being obtained together with a time at which the first data is obtained; a second acquisition unit that acquires second data related to a positional relationship regarding objects existing on a road together with a time at which the second data is obtained; a comparison unit that compares the first data and the second data based on the time of individual acquisition of the first data and the second data; a correction information generation unit that generates correction data to be used for correcting an output of the first sensor unit based on a comparison result of the comparison unit; and a transmission unit that transmits the correction data to the vehicle.

### BRIEF DESCRIPTION OF DRAWINGS

FIG. 1 is a diagram illustrating an outline of a vehicle control system according to a first embodiment.

FIG. 2 is a view illustrating an example of a distance marker.

FIG. 3 is a diagram illustrating an example of first data.

FIG. 4 is a diagram illustrating an example of second data.

FIG. 5 is a diagram illustrating an example of correction data.

FIG. 6 is a hardware block diagram illustrating an example of a hardware configuration of an RSU according to the first embodiment.

FIG. 7 is a hardware block diagram illustrating an example of a hardware configuration of a vehicle.

FIG. 8 is a functional block diagram illustrating an example of a functional configuration of the vehicle control system according to the first embodiment.

FIG. 9 is a flowchart illustrating an example of a flow of processing performed by the vehicle control system according to the first embodiment.

FIG. 10 is a functional block diagram illustrating an example of a functional configuration of a vehicle control system according to a modification of the first embodiment.

FIG. 11 is a functional block diagram illustrating an example of a functional configuration of a vehicle control system according to a second embodiment.

FIG. 12 is a flowchart illustrating an example of a flow of processing performed by the vehicle control system according to the second embodiment.

### DESCRIPTION OF EMBODIMENTS

Embodiments of the present disclosure will be described below in detail with reference to the drawings. In each of the following embodiments, the same parts are denoted by the same reference numerals, and a repetitive description thereof will be omitted.

The present disclosure will be described in the following order.

### 1. First Embodiment

1-1. Overview of ADAS

1-2. Outline of vehicle control system

1-3. First data and second data

1-4. Comparison between first data and second data

1-5. Correction data

1-6. Handling temporary decrease in sensor accuracy

1-7. Hardware configuration of RSU

1-8. Hardware configuration of vehicle

1-9. Functional configuration of vehicle control system

1-10. Flow of processing performed by vehicle control system

1-11. Effects of first embodiment

2. Modification of first embodiment

2-1. Functional configuration of vehicle control system

2-2. Effects of modification of first embodiment

3. Second Embodiment

3-1. Functional configuration of vehicle control system

3-2. Flow of processing performed by vehicle control system

3-3. Effects of second embodiment

### 1. First Embodiment

Before describing embodiments of the present disclosure, prerequisites for the implementation of the embodiments will be described.

[1-1. Overview of ADAS]

Development of an advanced driver assistance system (ADAS) that assists human driving and a system that performs autonomous driving of a vehicle without human intervention is in progress. In order to actualize these systems, various sensors are mounted on the vehicle.

Examples of known ADAS include systems such as an adaptive cruise control system (ACC), a lane keeping assist system (LKA), a forward collision warning (FCW), and traffic sign recognition (TSR).

ACC is a function of performing cruise-controlled traveling while maintaining a constant distance from a preceding vehicle. The vehicle controls an accelerator and a brake of the vehicle so as to maintain a constant inter-vehicle distance detected by the sensor.

LKA is a function of detecting a lane on a road and warning a driver when the vehicle predicts lane departure.

FCW is a function of issuing a warning or urging an avoidance operation to the driver in a case where the risk of collision increases, such as a case where the inter-vehicle distance is short or a case where a preceding vehicle suddenly brakes.

TSR is a function of recognizing traffic signs such as temporary stop, entry prohibition, and speed limit from image data captured by a camera and providing appropriate traffic regulation information to the driver.

In order to implement these functions, the vehicle needs to measure an inter-vehicle distance, a positional relationship, a relative speed, and the like between the own vehicle and surrounding vehicles. Therefore, the vehicle includes sensors such as a millimeter wave radar, light detection and ranging (LiDAR), and cameras.

[1-2. Outline of Vehicle Control System}

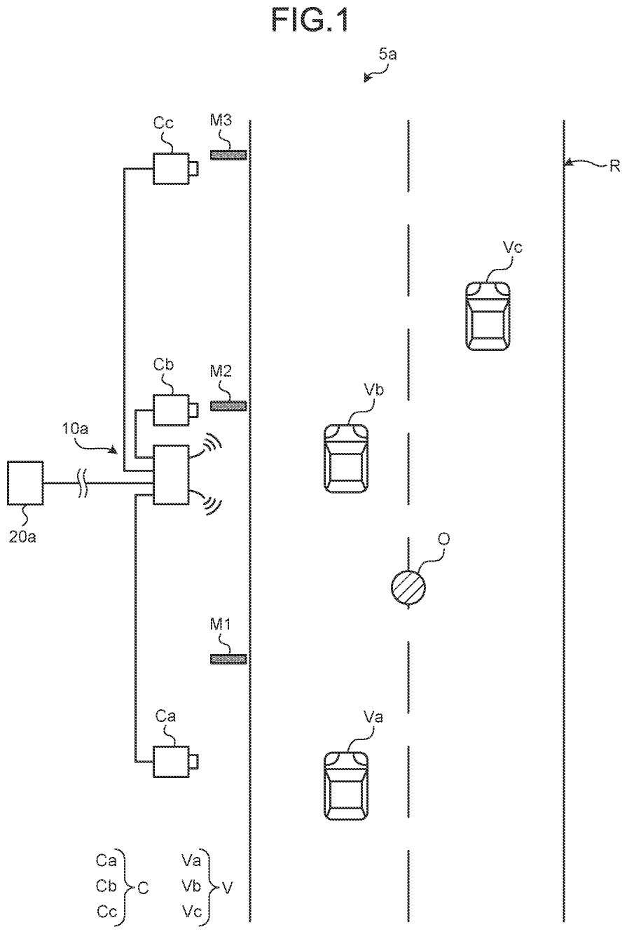

Next, an outline of a vehicle control system 5a being a first embodiment will be described with reference to FIG. 1. FIG. 1 is a diagram illustrating an outline of the vehicle control system according to the first embodiment. The vehicle control system 5a includes a roadside unit (RSU) 10a and vehicles V (Va, Vb, Vc, . . . ) on a road R in a region near the RSU 10a. The RSU 10a is installed in a roadside strip of the road R, and performs bidirectional radio communication with nearby vehicles within a limited range. The vehicle control system 5a is an example of an information processing system in the present disclosure. The RSU 10a is an example of an information processing apparatus in the present disclosure.

The vehicle equipped with the ADAS controls the vehicle while grasping a positional relationship with surrounding vehicles and objects by a sensor included in the vehicle. However, there has been a problem of difficulty in continuing accurate vehicle control at occurrence of deterioration in sensor accuracy.

The RSU 10a is installed at a position not disturbing traffic, such as at a road shoulder (curb) of the road R. In addition, the RSU 10a is installed in a predetermined region of the road R defined in advance. The RSU 10a performs bidirectional radio communication, for example, by dedicated short range communications (DSRC), with a vehicle V (Va, Vb, Vc, . . . ) in a region near the RSU 10a.

The RSU 10a acquires, from the vehicle V, first data D1 that is related to a positional relationship between the vehicle V and an object existing around the vehicle V and that is obtained by a sensor (hereinafter, referred to as an in-vehicle sensor) mounted on the vehicle V. Here, the object is, for example, other vehicles Vb, Vc, . . . existing around a vehicle Va, a fallen object O on the road R, a distance marker M (M1, M2, M3, . . . ), and the like when the vehicle Va is set as a reference. The in-vehicle sensor is an example of a first sensor unit in the present disclosure.

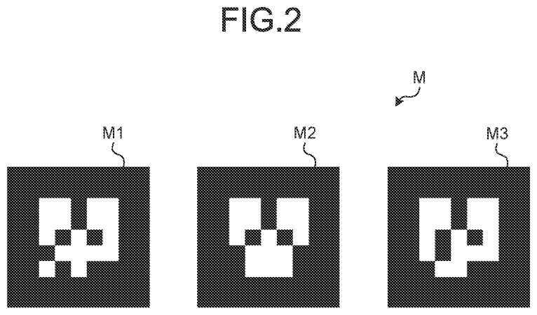

Near the RSU 10a, a plurality of distance markers M is installed along a road shoulder of the road R. The distance marker M is a plate-like mark installed at a predetermined interval such as 50 m or 100 m, and functions as a guide of the inter-vehicle distance. The distance marker M includes, for example, an illustration of a two-dimensional feature code referred to as an ALVAR code illustrated in FIG. 2. The ALVAR code is a type of two-dimensional barcode, and records positional information regarding a position where the ALVAR code is placed, for example. For example, a camera, which is an example of an in-vehicle sensor included in the vehicle V, reads the ALVAR code to detect the positional information regarding the installation location of the ALVAR code. As long as the distance marker M can be detected by an in-vehicle sensor mounted on the vehicle V, the distance marker M is not limited to the form of FIG. 2 and thus, the may be, for example, a text sign. In addition, the distance marker M may be a light-emitting marker for easy recognition from the vehicle.

The RSU 10a acquires, as the first data D1, information indicating a positional relationship between the vehicle V and another vehicle (a relative positional relationship with the vehicle V, an inter-vehicle distance, or the like) obtained by the vehicle V, information indicating a positional relationship between the vehicle V and an object such as the fallen object O or the distance marker M on a road (a relative positional relationship with the vehicle V, a distance to each object, or the like), and acquisition time of these pieces of information.

In addition, the RSU 10a includes cameras C (Ca, Cb, and Cc) that are installed above the road R to observe an entire range within which the RSU 10a can perform radio communication. Note that the number of installed cameras C is not limited. The RSU 10a acquires an image observed by the cameras C and analyzes the image to acquire second data D2 related to the positional relationship regarding objects existing on the road R. The second data D2 is data obtained for the same object and can be compared with the first data D1. In addition, the second data D2 is assumed to indicate a stable measurement result at any time of day and in any weather. The camera C is an example of a second sensor unit in the present disclosure. The RSU 10a may include a different type of sensor instead of the camera C as long as it can acquire the second data D2 related to the positional relationship regarding objects existing on the road R, and examples of the different type of sensor include a millimeter wave radar, LiDAR, or two or more thereof. In that case, the millimeter wave radar and the LiDAR are not limited to those for in-vehicle use, and may be, for example, devices for larger scale measurement. Although the camera has a difficulty in acquiring the second data D2 in an environment with low visibility such as nighttime, the LiDAR or the millimeter wave radar can acquire the second data D2 even in such an environment. Furthermore, other sensors such as an infrared camera may be used complementarily. In addition, in a case where the RSU 10a and the vehicle V include the same type of sensor, the data to be compared is preferably data acquired from the same type of sensor.

The RSU 10a compares the first data D1 and the second data D2 obtained at a same time. When the sensor mounted on the vehicle V operates normally, the first data D1 and the second data D2 match. However, when the accuracy of the sensor mounted on the vehicle V decreases for some reason, the first data D1 and the second data D2 do not match.

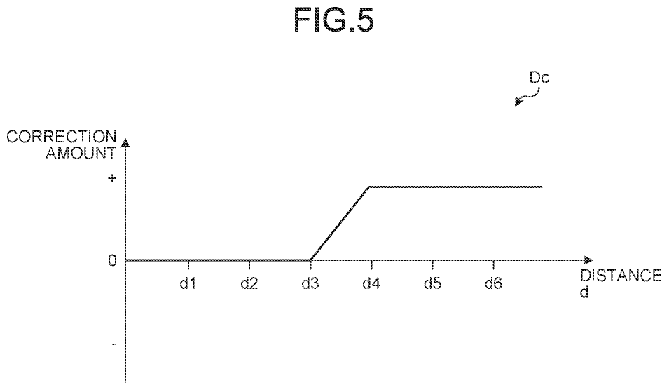

When the deviation between the first data D1 and the second data D2 is larger than a predetermined value, the RSU 10a generates correction data Dc (refer to FIG. 5) to be used for correcting the output of the sensor mounted on the corresponding vehicle.

The RSU 10a then transmits the generated correction data Dc to the vehicle V. The vehicle V corrects the measurement result of the sensor using the received correction data Dc and utilizes the correction result for control of the ADAS system.

Incidentally, the RSU 10a is connected to a server device 20a in remote location by wired communication or wireless communication, and acquires a program and the like necessary for controlling the RSU 10a from the server device 20a. In addition, the RSU 10a transmits information regarding the processing executed by the RSU 10a to the server device 20a so as to be stored.

[1-3. First Data and Second Data]

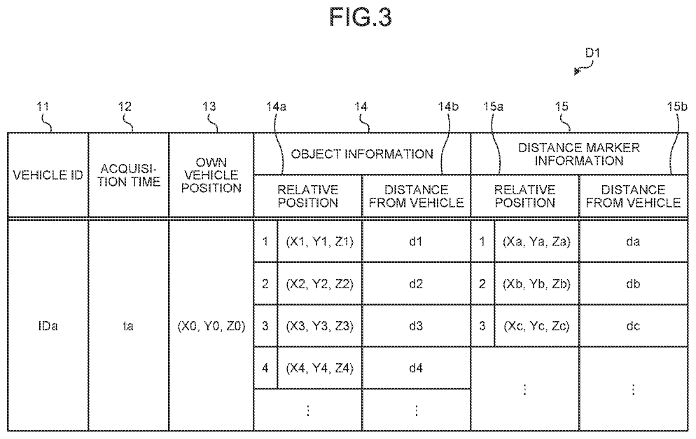

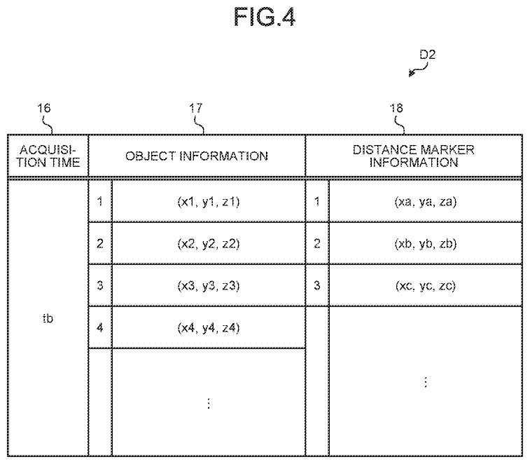

Details of the first data D1 and the second data D2 will be described. FIG. 3 is a diagram illustrating an example of first data. In particular, FIG. 3 illustrates an example of the first data D1 acquired by the RSU 10a from the vehicle Va. FIG. 4 is a diagram illustrating an example of second data.

As illustrated in FIG. 3, the first data D1 includes vehicle ID 11, an acquisition time 12, an own vehicle position 13, object information 14, and distance marker information 15.

The vehicle ID 11 is an identification number that is assigned to each vehicle V in advance to uniquely specify the vehicle V that has transmitted the first data D1.

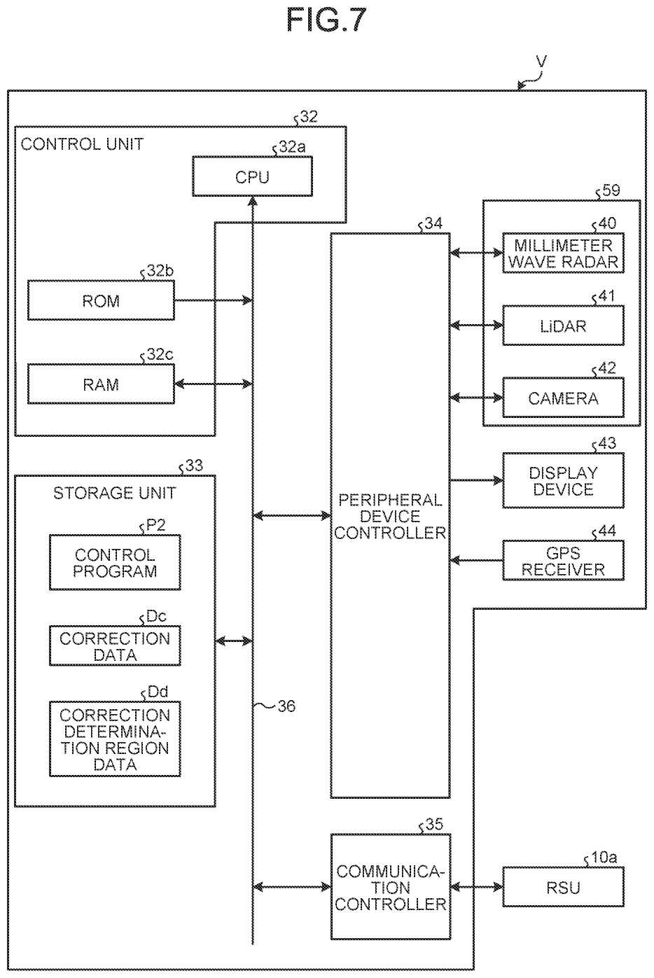

The acquisition time 12 is a time at which the vehicle V has obtained various types of information. Note that the acquisition time is a time obtained from a GPS receiver 44 (refer to FIG. 7) included in the vehicle V.

The own vehicle position 13 is position coordinates of the vehicle V at the time indicated by the acquisition time 12. Note that the position coordinates represent the position of vehicle V obtained by the GPS receiver 44, for example. The own vehicle position 13 may be expressed in the form of three-dimensional coordinates (X, Y, and Z) as illustrated in FIG. 3, or may be expressed in the form of latitude and longitude.

The object information 14 is information regarding a surrounding object detected by the vehicle V. The object information 14 includes a relative position 14a and a distance 14b from the vehicle V.

The relative position 14a indicates relative coordinates of the surrounding object viewed from the vehicle V. The relative coordinates are expressed by an XYZ coordinate system with an own vehicle position of each vehicle V as an origin, for example.

The distance 14b to the vehicle indicates a distance from vehicle V to the surrounding object.

Whether both the relative position 14a and the distance 14b to the vehicle can be obtained depends on the type of sensors mounted on the vehicle V. For example, when the vehicle V includes only a camera as a sensor for detecting a surrounding object, only the relative position 14a can be obtained. When the vehicle V includes only a millimeter wave radar, only the distance 14b to the vehicle can be obtained. When the vehicle V includes both a camera and a millimeter wave radar, or includes a LiDAR, it is possible to obtain both the relative position 14a and the distance 14b to the vehicle.

The distance marker information 15 is information related to the distance marker M detected by the vehicle V. The distance marker information 15 includes a relative position 15a and a distance 15b from the vehicle.

The relative position 15a indicates relative coordinates of the distance marker M as viewed from the vehicle V. The relative coordinates are expressed by an XYZ coordinate system with an own vehicle position of each vehicle V as an origin, for example.

The distance 15b to the vehicle indicates a distance from the vehicle V to the distance marker M. Whether both the relative position 15a and the distance 15b to the vehicle can be obtained depends on the type of sensors mounted on the vehicle V as described above.

As illustrated in FIG. 4, the second data D2 includes acquisition time 16, object information 17, and distance marker information 18. Note that it is sufficient as long as the second data D2 includes at least the distance marker information 18.

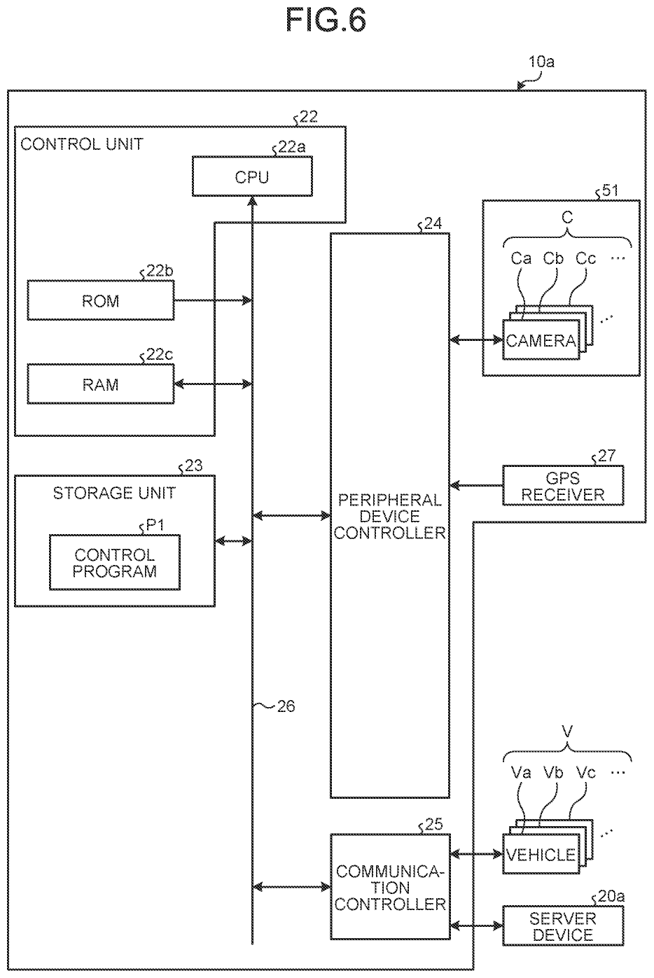

The acquisition time 16 is a time at which the camera C captures an image. Note that the acquisition time 16 is a time obtained from a GPS receiver 27 (refer to FIG. 6) included in the RSU 10a. Note that it is assumed that the cameras C (Ca, Cb, and Cc) simultaneously perform imaging.

The object information 17 is information related to an object (Vehicle V, fallen object O on road, or the like) on the road R detected by the RSU 10a based on the image captured by the camera C. The object information 17 is represented by position coordinates (x, y, z). The coordinate system xyz is a coordinate system set by the RSU 10a.

The distance marker information 18 is information indicating the position of the distance marker M detected by the RSU 10a based on the image captured by the camera C. Since the position of the distance marker M does not move once installed, it is not necessary to repeatedly detect the distance marker M. However, when the installation position moves or the distance marker M is damaged due to occurrence of disturbance such as bad weather or occurrence of a traffic accident, it is necessary to take measures such as not using the distance marker M. Therefore, the present embodiment detects the distance marker information 18 in order to confirm that the position of the distance marker M has not changed. The distance marker information 18 is represented by position coordinates (x, y, z). The coordinate system xyz is a coordinate system set by the RSU 10a.

[1-4. Comparison Between First Data and Second Data]

The RSU 10a sequentially acquires the second data D2 at predetermined time intervals (for example, a video rate). The RSU 10a then selects a piece of second data D2 acquired at the time equal to the acquisition time 12 of the first data D1 from among the pieces of acquired second data D2.

Subsequently, the RSU 10a converts the own vehicle position 13 of the vehicle V, the relative position 14a of the surrounding object, and the relative position 15a of the distance marker M, which are indicated by the first data D1, into the coordinate system xyz indicated by the second data D2, thereby obtaining which object of the second data D2 each object indicated by the first data D1 corresponds to. In addition, the RSU 10a obtains a correspondence between the relative position 15a of the distance marker M in the first data D1 and the distance marker information 18 in the second data D2.

In this manner, the RSU 10a compares the positional relationship between the specific vehicle V, the surrounding objects, and the distance marker M, indicated by the first data D1, with the information indicated by the second data D2. Subsequently, it is determined whether there is a deviation between the information indicated by the first data D1, that is, the positional relationship between the vehicle V and the surrounding objects detected by the vehicle V, and the information indicated by the second data D2, that is, the positional relationship between the vehicle V and the surrounding objects detected by the RSU 10a.

At this time, the information used for comparison may be arbitrarily determined, but at least the information regarding the distance marker M, which is fixed positional information, needs to be used in comparison at any time. That is, the distance between the different distance markers M calculated based on the distance 15b between each of the distance markers M and the vehicle V (for example, the distance between a distance marker M1 and a distance marker M2, the distance between the distance marker M2 and a distance marker M3) in the first data D1 is compared with the distance between the different distance markers M in the second data D2.

When there is no deviation between the first data D1 and the second data D2 as a result of the comparison, it is determined that the in-vehicle sensor mounted on the vehicle V is under normal operation. In contrast, when there is a deviation between the first data D1 and the second data D2, it is determined that the accuracy of the in-vehicle sensor of the vehicle V is deteriorated.

[1-5. Correction Data]

When there is a deviation between the first data D1 and the second data D2, the RSU 10a generates correction data Dc to be used for correcting the measurement result of the sensor mounted on the vehicle V so as to obtain a measurement result matching the second data D2.

In a case where the sensor is a millimeter wave radar or LiDAR, the correction data Dc is data representing a correction amount with respect to the distance to a target object.

FIG. 5 is a diagram illustrating an example of correction data. The correction data Dc illustrated in FIG. 5 is data obtained by the RSU 10a comparing data (distance measurement values) for the same vehicle V indicated by the first data D1 and the second data D2. FIG. 5 illustrates a case of correction to be performed in a case where it is known that, when a distance d to the target object measured by the millimeter wave radar is d4 or more, a distance shorter than the actual distance is detected. In this case, when the distance d is d4 or more, the measured distance d will be corrected on the positive side.

In addition, in a case where the sensor is a camera, the correction data Dc is data representing a correction amount for a threshold for recognition of the target object from a captured image. The threshold here is, for example, a threshold of brightness for detecting a vehicle or an object from an image, a threshold for detecting an edge representing an outline of an object, or the like.

[1-6. Handling Temporary Decrease in Sensor Accuracy]

The accuracy of the in-vehicle sensor can temporarily deteriorate because of a road environment, bad weather, nighttime, and the like. For example, a vehicle equipped with a millimeter wave radar can lose the sight of a preceding vehicle at a place having a large curvature of road. This phenomenon occurs when the preceding vehicle deviates from the distance measurement range. In such a case, the in-vehicle sensor itself is operating normally, and thus, there is no need to correct the sensor.

The RSU 10a of the present embodiment generates the correction data Dc based on the first data D1 acquired from a plurality of vehicles V existing nearby in the surroundings. That is, when the above-described phenomenon occurs, there is a high possibility that the same phenomenon occurs in another nearby vehicle V. Therefore, the RSU 10a determines the necessity of creating the correction data Dc of each vehicle V after confirming whether pieces of the first data D1 acquired from the plurality of vehicles V have similar tendencies. At this time, it is desirable to compare the first data D1 of the vehicles V traveling in the same direction.

The RSU 10a does not create the correction data Dc when similar phenomenon occurred in the plurality of vehicles V. In contrast, when a decrease in the accuracy of the sensor is recognized only in a specific vehicle V, the correction data Dc will be created for the specific vehicle V.

Note that, a scene in which the accuracy of the sensor temporarily deteriorates occurs in a case, in addition to the above, where the camera of the vehicle V fails to recognize a surrounding object at the time of backlight, a case where the camera of the vehicle V fails to recognize a surrounding object at the time of heavy rain, or the like. In either case, the same phenomenon is likely to occur in another vehicle V near the vehicle V. Therefore, the RSU 10a determines whether to create the correction data Dc based on the first data D1 acquired from the plurality of vehicles V.

[1-7. Hardware Configuration of RSU]

A hardware configuration of the RSU 10a according to the present embodiment will be described with reference to FIG. 6. FIG. 6 is a hardware block diagram illustrating an example of a hardware configuration of an RSU according to the first embodiment. The RSU 10a has a configuration in which a control unit 22, a storage unit 23, a peripheral device controller 24, and a communication controller 25 are connected to each other via an internal bus 26.

The control unit 22 is an arithmetic processing unit having a configuration of a computer and implements various functions of the RSU 10a. The control unit 22 includes a Central Processing Unit (CPU) 22a, Read Only Memory (ROM) 22b, and Random Access Memory (RAM) 22c.

The CPU 22a develops a control program P1 stored in the storage unit 23 or the ROM 22b onto the RAM 22c and executes the control program P1, thereby controlling the entire operation of the RSU 10a. Note that the control program P1 may be provided via a wired or wireless transmission medium such as a local area network, the Internet, or digital satellite broadcasting. Furthermore, the RSU 10a may execute all or a part of the series of processes by hardware.

The storage unit 23 includes a hard disk drive (HDD), a flash memory, and the like, and stores information such as the control program P1 executed by the CPU 22a.

The peripheral device controller 24 controls operations of the connected camera C (a second sensor unit 51) and the GPS receiver 27.

As described above, the camera C (Ca, Cb, and Cc), which is an example of the second sensor unit 51, acquires an image obtained by observing the road R.

By receiving a radio wave transmitted from a global positioning system (GPS) satellite, the GPS receiver 27 measures a position (latitude and longitude) of the GPS receiver 27. Furthermore, the GPS receiver 27 measures time.

The communication controller 25 connects the RSU 10a and the vehicle V (Va, Vb, Vc, . . . ) with each other. In addition, the communication controller 25 connects the RSU 10a and the server device 20a with each other.

[1-8. Hardware Configuration of Vehicle]

A hardware configuration of a portion of the vehicle V related to the RSU 10a of the present embodiment will be described with reference to FIG. 7. FIG. 7 is a hardware block diagram illustrating an example of a hardware configuration of a vehicle. The vehicle V (Va, Vb, Vc, . . . ) has a configuration in which a control unit 32, a storage unit 33, a peripheral device controller 34, and a communication controller 35 are connected to each other by an internal bus 36.

The control unit 32 is an arithmetic processing unit having a configuration of a computer that implements various functions by exchanging information with the RSU 10a. The control unit 32 includes a central processing unit (CPU) 32a, read only memory (ROM) 32b, and random access memory (RAM) 32c.

The vehicle V develops a control program P2 stored in the storage unit 33 or the ROM 32b onto the RAM 32c and executes the control program P2, thereby controlling the entire operation of the vehicle V. Note that the control program P2 may be provided via a wired or wireless transmission medium such as a local area network, the Internet, or digital satellite broadcasting. Furthermore, the vehicle V may execute all or a part of the series of processes by hardware.

The storage unit 33 includes a hard disk drive (HDD), a flash memory, or the like, and stores the control program P2 executed by the CPU 32a, the correction data Dc received from the RSU 10a, the correction determination region data Dd indicating the location of a region where confirmation and correction of the in-vehicle sensor are possible, and the like.

The peripheral device controller 34 is connected to: a millimeter wave radar 40, a LiDAR 41, and a camera 42, which are an example of an in-vehicle sensor (first sensor unit 59); a display device 43 such as a liquid crystal display that displays details of communication between the vehicle V and the RSU 10a, an application state of the correction data Dc, and the like as necessary; and the GPS receiver 44. The peripheral device controller 34 controls operation of these peripheral devices.

The communication controller 35 connects the vehicle V (Va, Vb, Vc, . . . ) and the RSU 10a with each other.

[1-9. Functional Configuration of Vehicle Control System]

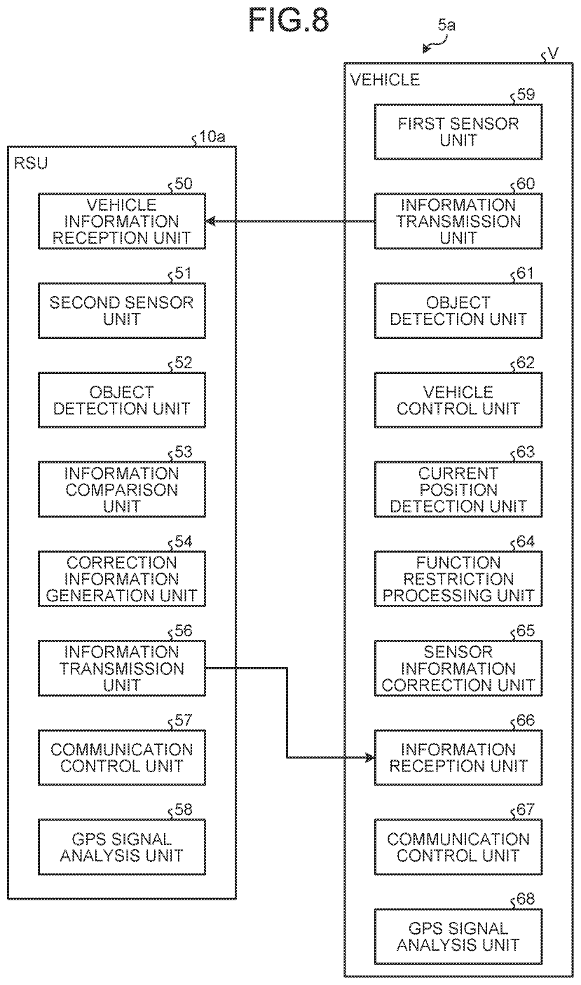

Next, a functional configuration of the vehicle control system 5a, which includes the RSU 10a and the vehicle V, will be described with reference to FIG. 8. FIG. 8 is a functional block diagram illustrating an example of a functional configuration of the vehicle control system according to the first embodiment.

The RSU 10a includes a vehicle information reception unit 50, a second sensor unit 51, an object detection unit 52, an information comparison unit 53, a correction information generation unit 54, an information transmission unit 56, a communication control unit 57, and a GPS signal analysis unit 58.

The vehicle information reception unit 50 acquires first data D1 related to the positional relationship between the vehicle V and an object existing around the vehicle V, which is obtained by the first sensor unit 59 mounted on the vehicle V, that is, by the in-vehicle sensor (the millimeter wave radar 40, the LiDAR 41, and the camera 42), together with the time at which the first data D1 is obtained. The vehicle information reception unit 50 is an example of a first acquisition unit in the present disclosure.

The second sensor unit 51 obtains the second data D2 related to the positional relationship regarding objects existing on the road R. Examples of the second sensor unit 51 include cameras C (Ca, Cb, and Cc).

The object detection unit 52 acquires the second data D2 related to the positional relationship regarding objects existing on the road together with the time at which the second data D2 is obtained. The object detection unit 52 is an example of a second acquisition unit in the present disclosure.

By comparing the first data D1 and the second data D2 obtained at the same time, the information comparison unit 53 calculates the magnitude of the deviation between the first data D1 and the second data D2. The information comparison unit 53 is an example of a comparison unit in the present disclosure.

The correction information generation unit 54 generates the correction data Dc used for correcting the output of the in-vehicle sensor of the vehicle V based on a comparison result of information comparison unit 53. The correction information generation unit 54 does not generate the correction data Dc for the plurality of vehicles V in a case where the magnitude of the deviation between the first data D1 and the second data D2 acquired from the plurality of vehicles V calculated by the information comparison unit 53 is all larger than a predetermined value.

The information transmission unit 56 transmits the correction data Dc to the vehicle V.

The communication control unit 57 controls communication between the RSU 10a and the vehicle V. Furthermore, the communication control unit 57 controls communication between the RSU 10a and the server device 20a (refer to FIG. 6).

The GPS signal analysis unit 58 analyzes details of the GPS signal received by GPS receiver 27 to acquire the time of acquisition of the first data D1.

Incidentally, the time acquired by the GPS signal analysis unit 58 is referred to when the vehicle V is synchronized with the time of acquisition of the second data D2 by the vehicle V.

The vehicle V includes a first sensor unit 59, an information transmission unit 60, an object detection unit 61, a vehicle control unit 62, a current position detection unit 63, a function restriction processing unit 64, a sensor information correction unit 65, an information reception unit 66, a communication control unit 67, and a GPS signal analysis unit 68.

The first sensor unit 59 (in-vehicle sensor) detects the first data D1 related to the positional relationship between the vehicle V and an object existing around the vehicle V. Examples of the first sensor unit 59 include the millimeter wave radar 40, the LiDAR 41, and the camera 42.

The information transmission unit 60 transmits, to the RSU 10a, the first data D1 related to the positional relationship between the vehicle V and an object existing around the vehicle V obtained by the first sensor unit 59 (in-vehicle sensor) mounted on the vehicle V, together with the time at which the first data D1 is obtained.

The object detection unit 61 detects an object and a distance marker M present on the road surface based on the measurement result of the in-vehicle sensor.

The vehicle control unit 62 performs various types of travel control of the vehicle V based on the measurement result of the in-vehicle sensor.

The current position detection unit 63 detects the current position of vehicle V based on the details of the GPS signal received by GPS receiver 44.

In a case where the deviation between the first data D1 and the second data D2 is larger than a predetermined value, the function restriction processing unit 64 imposes a restriction on the vehicle V such as prohibiting the use of the in-vehicle sensor related to the acquisition of the first data D1. When execution of the control function of the vehicle V is prohibited, the RSU 10a may transmit route guidance information to the nearest evacuation area to the vehicle V.

The sensor information correction unit 65 corrects the input/output characteristics of the in-vehicle sensor based on the correction data Dc (refer to FIG. 5).

The information reception unit 66 receives the correction data Dc transmitted by the RSU 10a.

The communication control unit 67 controls communication between the vehicle V and the RSU 10a.

The GPS signal analysis unit 68 analyzes details of the GPS signal received by GPS receiver 44 to acquire a current position and time of the vehicle V. Incidentally, the time acquired by the GPS signal analysis unit 68 is referred to when the RSU 10a is synchronized with the time of acquisition of the first data D1 by the RSU 10a.

[1-10. Flow of Processing Performed by Vehicle Control System]

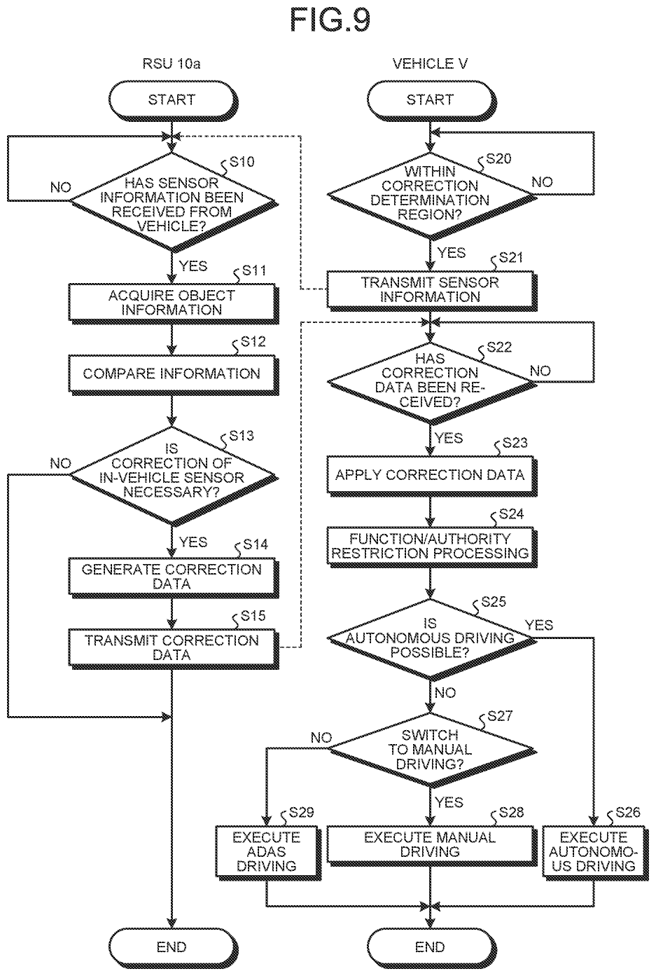

Next, a flow of processing performed by the vehicle control system 5a, that is, by the RSU 10a and the vehicle V, will be described with reference to FIG. 9. FIG. 9 is a flowchart illustrating an example of a flow of processing performed by the vehicle control system according to the first embodiment.

First, a flow of processing performed by the RSU 10a will be described. The vehicle information reception unit 50 determines whether the information regarding the in-vehicle sensor, that is, the first data D1 has been received from the vehicle V (step S10). When it is determined that the first data D1 has been received (step S10: Yes), the process proceeds to step S11. In contrast, when it is not determined that the first data D1 has been received (step S10: No), step S10 is repeated. The vehicle information reception unit 50 specifies the vehicle V that is a transmission source of the first data D1.

When the determination of step S10 is YES, the RSU 10a acquires the object information detected by the object detection unit 52 based on the output of the sensor unit 51, that is, acquires the second data D2 (step S11).

The information comparison unit 53 compares the first data D1 with the second data D2 (step S12).

The correction information generation unit 54 determines whether the correction of the in-vehicle sensor mounted on the vehicle V is necessary based on the comparison result of the information comparison unit 53 (step S13). When it is determined that correction of the in-vehicle sensor is necessary (step S13: Yes), the process proceeds to step S14. In contrast, when it is not determined that the correction of the in-vehicle sensor is necessary (step S13: No), the RSU 10a ends the processing of FIG. 9.

When the determination of step S13 is Yes, the correction information generation unit 54 generates the correction data Dc (step S14). In a case where there is a need to restrict the function/authority of the vehicle V at the time of correction, the correction information generation unit 54 simultaneously generates the information indicating the restriction.

Next, the information transmission unit 56 transmits the correction data Dc to the vehicle V that is a transmission source of the first data D1 (step S15). Thereafter, the RSU 10a ends the process of FIG. 9. In step S15, the RSU 10a may also transmit information indicating that the function/authority is to be restricted to the vehicle V.

Next, a flow of processing performed by the vehicle V will be described. First, the current position detection unit 63 analyzes the GPS signal received by the GPS receiver 44 to determine whether the vehicle V is near the RSU 10a, that is, in the correction determination region (step S20). When it is determined that the vehicle V is in the correction determination region (step S20: Yes), the process proceeds to step S21. In contrast, when it is not determined that the vehicle V is in the correction determination region (step S20: No), the determination in step S20 is repeated.

When the determination is Yes in step S20, the information transmission unit 60 transmits the sensor information (first data D1) related to the object existing on the road surface and the distance marker M detected by the object detection unit 61 to the RSU 10a (step S21).

The information reception unit 66 determines whether the correction data Dc has been received from the RSU 10a (step S22). When it is determined that the correction data Dc has been received from the RSU 10a (step S22: Yes), the process proceeds to step S23. In contrast, when it is not determined that the correction data Dc has been received from the RSU 10a (step S22: No), the determination in step S22 is repeated.

When the determination is Yes in step S22, the sensor information correction unit 65 corrects the input/output characteristics of the in-vehicle sensor based on the correction data Dc (step S23). When the correction data Dc is applied in step S23, it is desirable to display the fact of application on a monitor or the like of the vehicle V.

The function restriction processing unit 64 performs function/authority restriction processing such as prohibiting execution of a part of the control function of the vehicle V as necessary (step S24).

Furthermore, the function restriction processing unit 64 determines whether the vehicle V is capable of autonomous driving (step S25). When it is determined that the vehicle V is capable of autonomous driving (step S25: Yes), the process proceeds to step S26. When it is not determined that the vehicle V is capable of autonomous driving (step S25: No), the process proceeds to step S27.

When the determination of step S25 is Yes, the vehicle control unit 62 causes the vehicle V to execute autonomous driving. Thereafter, the vehicle V ends the process of FIG. 9.

In contrast, when the determination is No in step S25, the function restriction processing unit 64 determines whether to switch the vehicle V to manual driving (step S27). When it is determined that switching to manual driving is to be performed (step S27: Yes), the process proceeds to step S28. When it is not determined that switching to manual driving is to be performed (step S27: No), the process proceeds to step S29. Note that the function restriction processing unit 64 determines whether the vehicle V can continue the autonomous driving, the vehicle V should switch to the manual driving, or the vehicle V can continue the driver assistance by the in-vehicle sensor based on the degree of deviation between the first data D1 and the second data D2.

When the determination is Yes in step S27, the vehicle control unit 62 switches the vehicle V to manual driving (step S28). Thereafter, the vehicle V ends the process of FIG. 9.

When the determination is No in step S27, the vehicle control unit 62 controls the vehicle V to execute driver assistance by the in-vehicle sensor (step S29). Thereafter, the vehicle V ends the process of FIG. 9.

Although the first embodiment uses a case where the RSU 10a includes the camera C (sensor unit 51) and detects the position of the object on the road R, it is also allowable to register the installation position of the distance marker M in a database on the assumption that the position of the distance marker M is unchanged and allowable to calculate the distance between the different distance markers M with reference to the database.

[1-11. Effects of First Embodiment]

As described above, in the vehicle control system 5a (information processing system) according to the first embodiment, the information comparison unit 53 (comparison unit) compares the first data D1 related to the positional relationship between the vehicle V and an object existing around the vehicle V obtained by the vehicle information reception unit 50 (first acquisition unit) from the first sensor unit 59 (in-vehicle sensor (the millimeter wave radar 40, the LiDAR 41, and the camera 42)) that is mounted on the vehicle V and obtains the information related to the travel control of the vehicle V, with the second data D2 related to the positional relationship regarding objects existing on the road R obtained by the object detection unit 52 (second acquisition unit). Subsequently, the correction information generation unit 54 generates the correction data Dc to be used for correcting the output of the sensor based on the comparison result of the information comparison unit 53. The information transmission unit 56 (transmission unit) transmits the correction data Dc to the vehicle V.

This makes it possible to correct the output of the in-vehicle sensor based on the correction data Dc when the accuracy of the in-vehicle sensor of the vehicle V deteriorates, leading to prevention of the deterioration of the accuracy of the in-vehicle sensor. This enables continuation of the travel control of the vehicle V.

The vehicle control system 5a (information processing system) of the first embodiment further includes the camera C (second sensor unit 51) that obtains the second data D2.

This makes it possible to install, on the RSU 10a, a sensor with higher accuracy and higher stability than the in-vehicle sensor included in the vehicle V, leading to acquisition of accurate information regarding the positional relationship between the vehicle V and the object existing around the vehicle V.

In addition, in the vehicle control system 5a (information processing system) of the first embodiment, the information comparison unit 53 (comparison unit) is provided in the roadside unit (RSU) 10a installed near the road R, and calculates the magnitude of the deviation between the second data D2 and the first data D1.

This makes it possible to compare the second data D2 and the first data D1 easily and reliably.

In addition, in the vehicle control system 5a (information processing system) of the first embodiment, the information comparison unit 53 (comparison unit) compares the first data D1 and the second data D2 obtained at the same time.

This makes it possible to correct the first data D1 using the second data D2 obtained at the same time.

In addition, in the vehicle control system 5a (information processing system) of the first embodiment, the correction information generation unit 54 is provided in the roadside unit (RSU) 10a installed near the road R, and does not generate the correction data Dc for a plurality of vehicles V in a case where the magnitude of the deviation between the first data D1 and the second data D2 acquired from the plurality of vehicles V calculated by the information comparison unit 53 (comparison unit) is all larger than a predetermined value.

This makes it possible to prevent erroneous connection of the sensor when the accuracy of the in-vehicle sensor temporarily deteriorates due to factors such as weather.

In addition, in the vehicle control system 5a (information processing system) of the first embodiment, the vehicle V further includes the function restriction processing unit 64 that restricts the use of the first sensor unit 59 based on the information that restricts the use of the first sensor unit 59.

With this configuration, when the deviation between the first data D1 and the second data D2 is large, it is possible, for example, to apply the function restriction to the vehicle V such as not permitting the autonomous driving.

In addition, the vehicle control system 5a (information processing system) of the first embodiment synchronizes the acquisition time of the first data D1 and the acquisition time of the second data D2 by using the time obtained from the GPS receivers 27 and 44.

This makes it possible to compare the first data D1 and the second data D2 acquired at the same time.

In addition, the vehicle control system 5a (information processing system) of the first embodiment acquires the first data D1 and the second data D2 in a predetermined region (correction determination region) of the road R.

This makes it possible to determine a place where the RSU 10a is highly installable as the correction determination region.

In addition, in the vehicle control system 5a (information processing system) of the first embodiment, the object is a distance marker M (marker) installed on the road R, and the first data D1 and the second data D2 represent the distance between the vehicle V and the distance marker M.

This makes it possible to evaluate the accuracy of the in-vehicle sensor of the vehicle V based on the positional relationship between the vehicle V and the distance marker M even when there is no other vehicle around the vehicle V.

Furthermore, the RSU 10a (information processing apparatus) according to the first embodiment, the information comparison unit 53 (comparison unit) compares the first data D1 related to the positional relationship between the vehicle V and an object existing around the vehicle V obtained by the vehicle information reception unit 50 (first acquisition unit) from the in-vehicle sensor (the millimeter wave radar 40, the LiDAR 41, and the camera 42) that is mounted on the vehicle V and obtains the information related to the travel control of the vehicle V, with the second data D2 related to the positional relationship regarding objects existing on the road R obtained by the object detection unit 52 (second acquisition unit) based on the time of individual acquisition of the first data D1 and the second data D2. Subsequently the correction information generation unit 54 generates correction data Dc to be used for correcting the output of the sensor based on the comparison result of information comparison unit 53, and then the information transmission unit 56 (transmission unit) transmits the correction data Dc to the vehicle V.

This makes it possible to correct the output of the first sensor unit 59 based on the correction data Dc when the accuracy of the first sensor unit 59 (in-vehicle sensor) of the vehicle V deteriorates, leading to prevention of the deterioration of the accuracy of the first sensor unit 59. This enables continuation of the travel control of the vehicle V.

### 2. Modification of First Embodiment

Next, a modification of the first embodiment will be described. The modification of the first embodiment is an example in which the functions performed by the RSU 10a in the first embodiment is partially implemented by a server device 20b to form a vehicle control system 5b. That is, the vehicle control system 5b includes the server device 20b, an RSU 10b, and a vehicle V. The vehicle control system 5b is an example of an information processing system The server device 20b is an example of an information processing apparatus in the present disclosure.

[2-1. Functional Configuration of Vehicle Control System]

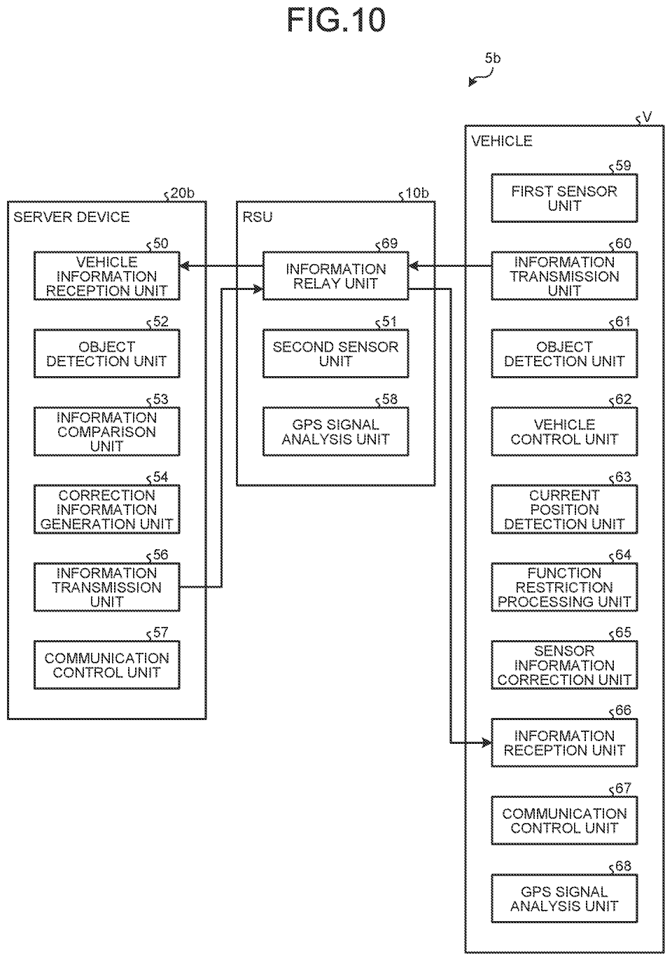

The functional configurations of the server device 20b, the RSU 10b, and the vehicle V will be described with reference to FIG. 10. FIG. 10 is a functional block diagram illustrating an example of a functional configuration of the vehicle control system according to a modification of the first embodiment.

The server device 20b includes a vehicle information reception unit 50, an object detection unit 52, an information comparison unit 53, a correction information generation unit 54, an information transmission unit 56, and a communication control unit 57. Since the function of each portion is as described in the first embodiment, the description thereof is omitted.

The RSU 10b includes a sensor unit 51, a GPS signal analysis unit 58, and an information relay unit 69. Since the sensor unit 51 and the GPS signal analysis unit 58 have the functions as described in the first embodiment, the description thereof is omitted.

The information relay unit 69 relays information communication between the server device 20b and the vehicle V. That is, the information relay unit 69 receives the first data D1 acquired by the vehicle V and transmits the received first data D1 to the server device 20b. In addition, the information relay unit 69 transmits the second data D2 acquired by the RSU 10b to the server device 20b. Furthermore, information relay unit 69 receives correction data Dc generated by the server device 20b, and transmits the received correction data Dc to the vehicle V.

Since the functional configuration of the vehicle V is as described in the first embodiment (refer to FIG. 8), the description thereof will be omitted.

The flow of processing performed by the vehicle control system 5b is a modification of the flow of processing (refer to FIG. 9) performed by the vehicle control system 5a described in the first embodiment, and has basic processing details similar to the first embodiment, and thus, description thereof is omitted. That is, the flow of the processing performed by the vehicle control system 5b is obtained by redistributing the processing performed by the RSU 10a in the vehicle control system 5a into processing performed by the server device 20b and processing performed by the RSU 10b.

[2-2. Effects of Modification of First Embodiment]

As described above, the vehicle control system 5a (information processing system) according to the modification of the first embodiment includes the server device 20b communicably connected to the roadside unit (RSU) 10b, in which the server device 20b includes the vehicle information reception unit 50 (first acquisition unit), the object detection unit 52 (second acquisition unit), the information comparison unit 53 (comparison unit), the correction information generation unit 54, and the information transmission unit 56 (transmission unit).

With this configuration, the processing function of each RSU 10a described in the first embodiment can be executed by the server device 10b, making it possible to reduce the processing load on the RSU 10b. That is, since the RSU 10b can be installed at low cost, more RSUs 10b can be installed at the same cost.

### 3. Second Embodiment

Next, a second embodiment of the present disclosure will be described. In a case where the correction data Dc generated by the RSU 10a in the first embodiment is applied to the vehicle V, it is desirable to confirm whether the correction data Dc can be reliably applied. The second embodiment has a determination function of determining applicability of the correction data Dc to the vehicle V.

[3-1. Functional Configuration of Vehicle Control System]

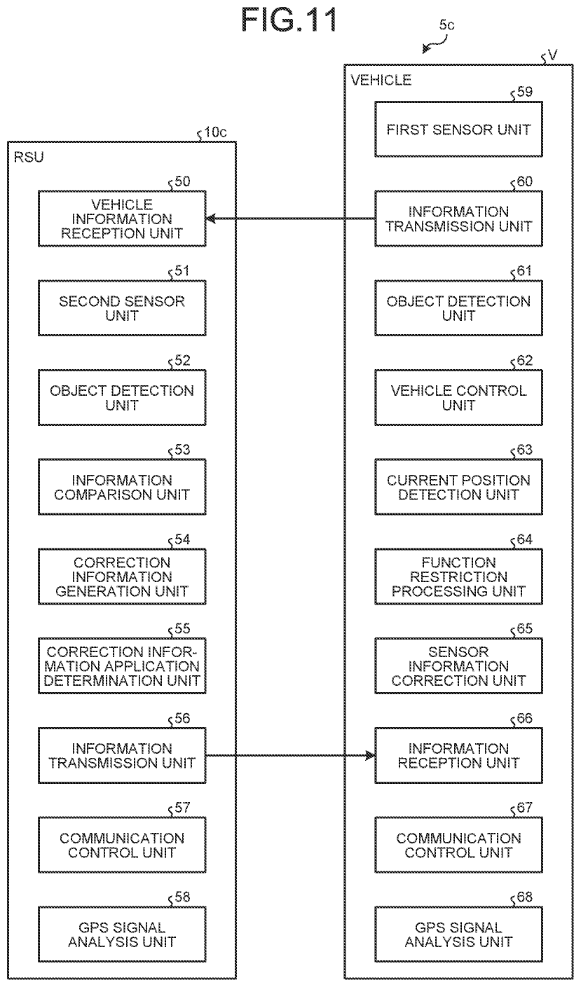

The functional configurations of an RSU 10c and a vehicle V will be described with reference to FIG. 11. FIG. 11 is a functional block diagram illustrating an example of a functional configuration of the vehicle control system according to the second embodiment. A vehicle control system 5c described in the second embodiment is based on a vehicle control system 5a (refer to FIG. 8). The vehicle control system 5c may be configured based on the vehicle control system 5b as well (refer to FIG. 10).

The RSU 10c according to the second embodiment has a configuration in which a correction information application determination unit 55 is added to the configuration of the RSU 10a according to the first embodiment.

The correction information application determination unit 55 determines the applicability of the correction data Dc to the vehicle V based on the comparison result by the information comparison unit 53. The correction information application determination unit 55 is an example of an application determination unit in the present disclosure.

After generating the correction data Dc and transmitting the correction data Dc to the vehicle V, the correction information application determination unit 55 determines applicability of the correction data Dc at subsequent existing positions of the RSU 10c (that is, the correction determination region). Note that the RSU 10c is assumed to be installed in plurality at predetermined intervals. Specifically, the vehicle V transmits to the RSU 10c first data D1 obtained at application of the correction data Dc. Subsequently, the correction information application determination unit 55 makes a determination of applicability of the correction data Dc based on a result of comparison between the first data D1 and the second data D2 obtained by the RSU 10c.

When having determined to apply the correction data Dc, the correction information application determination unit 55 notifies the vehicle V of the determination. When having received the information regarding the determination to apply the correction data Dc, the vehicle V enables correction and applies the correction data Dc thereafter.

When having determined not to apply the correction data Dc, the correction information application determination unit 55 notifies the vehicle V of the determination. When having received the information indicating that the correction data Dc is not to be applied, the vehicle V disables the correction of the in-vehicle sensor. Incidentally, the state of application of the correction data Dc or non-application of the correction data Dc is displayed on the display device 43 included in the vehicle V to notify the driver of the vehicle V.

When having determined that the correction data Dc is not applicable to the vehicle V, the correction information application determination unit 55 may cause the information transmission unit 56 to transmit information to prohibit the use of the in-vehicle sensor to the vehicle V.

[3-2. Flow of Processing Performed by Vehicle Control System]

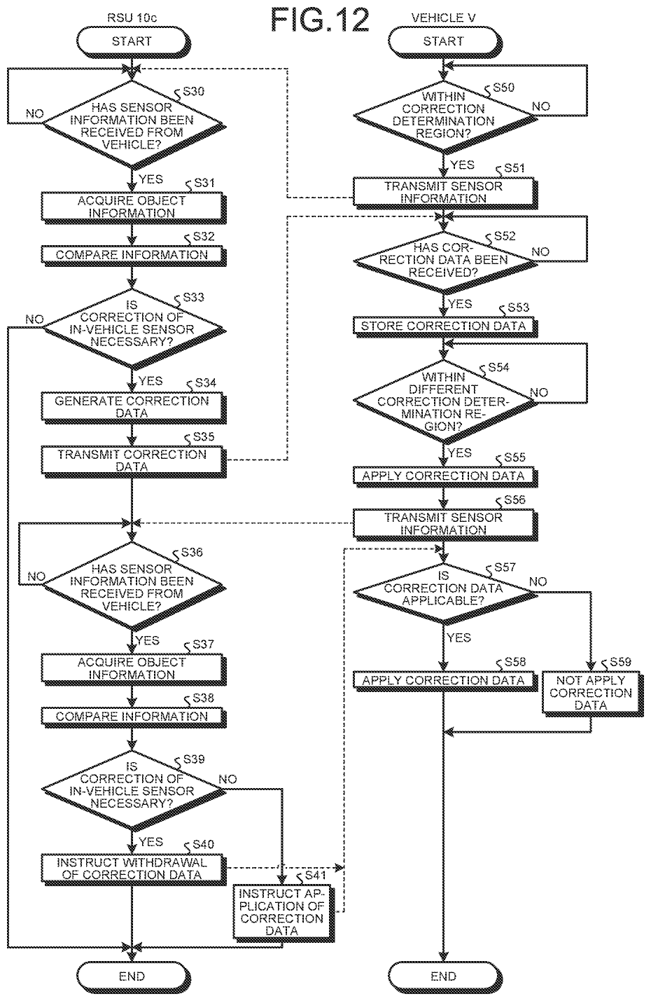

Next, a flow of processing performed by the vehicle control system 5c, that is, by the RSU 10c and the vehicle V, will be described with reference to FIG. 12. FIG. 12 is a flowchart illustrating an example of a flow of processing performed by the vehicle control system according to the second embodiment.

First, a flow of processing performed by the RSU 10c will be described. Since the processing performed in steps S30 to S35 in FIG. 12 is same as the processing performed in steps S10 to S15 by the RSU 10a described in FIG. 9, the description thereof will be omitted.

After these steps, the vehicle information reception unit 50 determines, in a different correction determination region, whether the information regarding the in-vehicle sensor, that is, the first data D1 has been received from the vehicle V (step S36). When it is determined that the first data D1 has been received (step S36: Yes), the process proceeds to step S37. In contrast, when it is not determined that the first data D1 has been received (step S36: No), step S36 is repeated. The vehicle information reception unit 50 specifies the vehicle V that is a transmission source of the first data D1.

When the determination of step S36 is YES, the RSU 10c acquires the object information detected by the object detection unit 52 based on the output of the sensor unit 51, that is, acquires the second data D2 (step S37).

The information comparison unit 53 compares the first data D1 with the second data D2 (step S38).

The correction information generation unit 54 determines whether the correction of the in-vehicle sensor mounted on the vehicle V is necessary based on the comparison result of the information comparison unit 53 (step S39). When it is determined that correction of the in-vehicle sensor is necessary (step S39: Yes), the process proceeds to step S40. In contrast, when it is not determined that the correction of the in-vehicle sensor is necessary (step S39: No), the process proceeds to step S41.

When the determination is Yes in step S39, the correction information application determination unit 55 instructs the vehicle V to withdraw the correction data Dc (step S40). Specifically, the information transmission unit 56 transmits, to vehicle V, an indication to withdraw the correction data Dc. Thereafter, the RSU 10c ends the process of FIG. 12. When the correction data Dc is withdrawn, new correction data Dc may be generated based on the magnitude of the deviation between the first data D1 and the second data D2 calculated in step S38.

In contrast, when the determination is No in step S39, the correction information application determination unit 55 instructs the vehicle V to apply the correction data Dc (step S41). Specifically, the information transmission unit 56 transmits, to vehicle V, an indication to apply the correction data Dc. Thereafter, the RSU 10c ends the process of FIG. 12.

First, a flow of processing performed by the vehicle V will be described. First, the current position detection unit 63 analyzes the GPS signal received by the GPS receiver 44 to determine whether the vehicle V is near the RSU 10c, that is, in the correction determination region (step S50). When it is determined that the vehicle V is in the correction determination region (step S50: Yes), the process proceeds to step S51. In contrast, when it is not determined that the vehicle V is in the correction determination region (step S50: No), the determination in step S50 is repeated.

When the determination is Yes in step S50, the information transmission unit 60 transmits the sensor information (first data D1) related to the object existing on the road surface and the distance marker M detected by the object detection unit 61 to the RSU 10c (step S51).

The information reception unit 66 determines whether the correction data Dc has been received from the RSU 10c (step S52). When it is determined that the correction data Dc has been received from the RSU 10c (step S52: Yes), the process proceeds to step S53. In contrast, when it is not determined that the correction data Dc has been received from the RSU 10a (step S52: No), the determination in step S52 is repeated.

When the determination is Yes in step S52, the sensor information correction unit 65 stores the correction data Dc (step S53).

Next, the current position detection unit 63 analyzes the GPS signal received by GPS receiver 44 to determine whether the vehicle V is in a correction determination region different from the correction determination region determined in step S50 (step S54). When it is determined that the vehicle V is in the different correction determination region (step S54: Yes), the process proceeds to step S55. In contrast, when it is not determined that the vehicle V is in the different correction determination region (step S54: No), the determination in step S54 is repeated.

When the determination is Yes in step S54, the sensor information correction unit 65 applies the correction data Dc to the in-vehicle sensor of the vehicle V (step S55).

Next, the information transmission unit 60 transmits the sensor information (first data D1) related to the object existing on the road surface and the distance marker M detected by the object detection unit 61 to the RSU 10c (step S56).

The sensor information correction unit 65 determines whether the correction data Dc is applicable based on the information regarding the applicability of the correction data Dc received by the information reception unit 66 from the RSU 10c (step S57). When it is determined that the correction data Dc is applicable (step S57: Yes), the process proceeds to step S58. In contrast, when it is not determined that the correction data Dc is applicable (step S57: No), the process proceeds to step S59.

When the determination is Yes in step S57, the sensor information correction unit 65 applies the correction data Dc. Thereafter, the vehicle V ends the process of FIG. 12.

When the determination is No in step S57, the sensor information correction unit 65 will not apply the correction data Dc. Thereafter, the vehicle V ends the process of FIG. 12. When new correction data Dc is generated, the process of FIG. 12 may be executed again in the next correction determination region to determine the applicability of a new piece of the correction data Dc.

[3-3. Effects of Second Embodiment]

As described above, in the vehicle control system 5c (information processing system) of the second embodiment, the vehicle information reception unit 50 (first acquisition unit) applies the correction data Dc transmitted by the information transmission unit 56 (transmission unit) to the in-vehicle sensor (the millimeter wave radar 40, the LiDAR 41, and the camera 42), and then acquires the first data D1 obtained by the in-vehicle sensor. Subsequently, the correction information application determination unit 55 (application determination unit) determines applicability of the correction data Dc to the vehicle V based on a comparison result of the information comparison unit 53 (comparison unit). Next, the Information transmission unit 56 (transmission unit) transmits the determination result of the correction information application determination unit 55 to the vehicle V.

With this configuration, determination of applicability of the correction data Dc is made based on the first data D1 obtained at application of the correction data Dc, the correction can be reliably performed only when the correction of the in-vehicle sensor is really necessary.

In addition, the vehicle control system 5c (information processing system) of the second embodiment includes, in the vehicle V, the sensor information correction unit 65 that applies the correction data Dc to the first sensor unit 59 (in-vehicle sensor).

With this configuration, the vehicle V can correct the output of the in-vehicle sensor by applying the correction data Dc to the first sensor unit 59 (in-vehicle sensor).

Furthermore, in the vehicle control system 5c (information processing system) according to the second embodiment, when the correction information application determination unit 55 (application determination unit) has determined that the correction data Dc is not applicable to the vehicle V, the information transmission unit 56 (transmission unit) transmits information to prohibit the use of the in-vehicle sensor (the millimeter wave radar 40, the LiDAR 41, and the camera 42) to the vehicle V.

With this configuration, it is possible to prohibit the use of the in-vehicle sensor when the accuracy of the in-vehicle sensor is unstable.

The effects described in the present specification are merely examples, and thus, there may be other effects, not limited to the exemplified effects. Furthermore, the embodiment of the present disclosure is not limited to the above-described embodiment, and various modifications can be made without departing from the scope and spirit of the present disclosure.

In addition, the first data D1 and the second data D2 to be used for comparison may be data locally pre-processed in each individual sensor, which is referred to as processed data, or may be data not locally pre-processed in each individual sensor, which is referred to as raw data (unprocessed data). In a case where processed data is used, processing is locally performed in advance including elimination of unnecessary information such as noise, making it possible to reduce the load on the subsequent processing, leading to achievement of processing at a relatively high speed. In contrast, in a case where raw data is used, the amount of information is abundant since the raw data is not locally processed in advance, making it possible to perform data comparison using a larger amount of information compared with the case where the processed data is used. In addition, processed data may be used for one of both data, and raw data may be used for the other data.

The present disclosure may have the following configurations.

(1)

An information processing system comprising: a first acquisition unit that acquires first data related to a positional relationship between a vehicle and an object existing around the vehicle, the first data being obtained by a first sensor unit that is mounted on the vehicle and obtains information related to travel control of the vehicle, the first data being obtained together with a time at which the first data is obtained;

a second acquisition unit that acquires second data related to a positional relationship regarding objects existing on a road together with a time at which the second data is obtained;

a comparison unit that compares the first data and the second data based on the time of individual acquisition of the first data and the second data;

a correction information generation unit that generates correction data to be used for correcting an output of the first sensor unit based on a comparison result of the comparison unit; and

a transmission unit that transmits the correction data to the vehicle.

(2)

The information processing system according to (1), further comprising

a second sensor unit that obtains the second data,

wherein the second sensor unit is provided in a roadside unit (RSU) installed near a road.

(3)

The information processing system according to (1) or (2),

wherein the comparison unit is provided in a roadside unit (RSU) installed near a road,

the comparison unit configured to calculate a magnitude of a deviation between the first data and the second data.

(4)

The information processing system according to any one of (1) to (3),

wherein the comparison unit

compares the first data and the second data obtained at a same time.

(5)

The information processing system according to any one of (1) to (4),

wherein the correction information generation unit is provided in a roadside unit (RSU) installed near a road, and

the correction information generation unit does not generate the correction data for the plurality of vehicles when a magnitude of deviation between the first data and the second data acquired from a plurality of vehicles calculated by the comparison unit is all larger than a predetermined value.

(6)

The information processing system according to any one of (1) to (5),

wherein the first acquisition unit applies the correction data transmitted by the transmission unit to the first sensor unit and thereafter acquires the first data obtained by the first sensor unit,

the information processing system further comprises an application determination unit that determines applicability of the correction data to the vehicle based on a comparison result of the comparison unit, and

the transmission unit is provided in a roadside unit (RSU) installed near a road, the transmission unit configured to transmit a determination result of the application determination unit to the vehicle.

(7)

The information processing system according to (6),

wherein, in a case where the application determination unit has determined that the correction data is not applicable to the vehicle,

the transmission unit transmits information to restrict use of the first sensor unit, to the vehicle.

(8)

The information processing system according to any one of (1) to (7), further comprising

a sensor information correction unit that applies the correction data to the first sensor unit,

wherein the sensor information correction unit is provided in the vehicle.

(9)

The information processing system according to any one of (1) to (8), further comprising

a function restriction processing unit that restricts use of the first sensor unit based on information to restrict the use of the first sensor unit,

wherein the function restriction processing unit is provided in the vehicle.

(10)

The information processing system according to any one of (1) to (9),

wherein an acquisition time of the first data and an acquisition time of the second data are synchronized with each other by a time obtained from a GPS receiver.

(11)

The information processing system according to any one of (1) to (10),

wherein the information processing system

acquires the first data and the second data in a predetermined region of a road.

(12)

The information processing system according to any one of (1) to (11),

wherein the object is a marker installed on a road, and

the first data and the second data represent a distance between the vehicle and the marker.

(13)

The information processing system according to any one of (2) to (12),

wherein the information processing system further comprises a server device communicably connected to the roadside unit (RSU), and

the server device includes the first acquisition unit, the second acquisition unit, the comparison unit, the correction information generation unit, and the transmission unit.

(14)

An information processing method comprising:

a first acquisition step of acquiring first data related to a positional relationship between a vehicle and an object existing around the vehicle, the first data being obtained by a first sensor unit that is mounted on the vehicle and obtains information related to travel control of the vehicle, the first data being obtained together with a time at which the first data is obtained;

a second acquisition step of acquiring second data related to a positional relationship regarding objects existing on a road together with a time at which the second data is obtained;

a comparison step of comparing the first data and the second data based on the time of individual acquisition of the first data and the second data;

a correction information generation step of generating correction data to be used for correcting an output of the first sensor unit based on a comparison result of the comparison step; and

a transmission step of transmitting the correction data to the vehicle.

(15)

An information processing apparatus comprising:

a first acquisition unit that acquires first data related to a positional relationship between a vehicle and an object existing around the vehicle, the first data being obtained by a first sensor unit that is mounted on the vehicle and obtains information related to travel control of the vehicle, the first data being obtained together with a time at which the first data is obtained;

a second acquisition unit that acquires second data related to a positional relationship regarding objects existing on a road together with a time at which the second data is obtained;

a comparison unit that compares the first data and the second data based on the time of individual acquisition of the first data and the second data;

a correction information generation unit that generates correction data to be used for correcting an output of the first sensor unit based on a comparison result of the comparison unit; and

a transmission unit that transmits the correction data to the vehicle.

### REFERENCE SIGNS LIST

5a, 5b, 5c VEHICLE CONTROL SYSTEM (INFORMATION PROCESSING SYSTEM)
10a, 10c RSU (INFORMATION PROCESSING APPARATUS)
10b RSU
20a SERVER DEVICE
20b SERVER DEVICE (INFORMATION PROCESSING APPARATUS)
50 VEHICLE INFORMATION RECEPTION UNIT (FIRST ACQUISITION UNIT)
51 SECOND SENSOR UNIT
52 OBJECT DETECTION UNIT (SECOND ACQUISITION UNIT)
53 INFORMATION COMPARISON UNIT (COMPARISON UNIT)
54 CORRECTION INFORMATION GENERATION UNIT
55 CORRECTION INFORMATION APPLICATION DETERMINATION UNIT (APPLICATION DETERMINATION UNIT)
56 INFORMATION TRANSMISSION UNIT (TRANSMISSION UNIT)
59 FIRST SENSOR UNIT (IN-VEHICLE SENSOR)
64 FUNCTION RESTRICTION PROCESSING UNIT
C, Ca, Cb, Cc CAMERA
V, Va, Vb, Vc VEHICLE
D1 FIRST DATA
D2 SECOND DATA
Dc CORRECTION DATA
M, M1, M2, M3 DISTANCE MARKER
R ROAD

1. An information processing system comprising:
a first acquisition unit that acquires first data related to a positional relationship between a vehicle and an object existing around the vehicle, the first data being obtained by a first sensor unit that is mounted on the vehicle and obtains information related to travel control of the vehicle, the first data being obtained together with a time at which the first data is obtained;
a second acquisition unit that acquires second data related to a positional relationship regarding objects existing on a road together with a time at which the second data is obtained;
a comparison unit that compares the first data and the second data based on the time of individual acquisition of the first data and the second data;
a correction information generation unit that generates correction data to be used for correcting an output of the first sensor unit based on a comparison result of the comparison unit; and
a transmission unit that transmits the correction data to the vehicle.

2. The information processing system according to claim 1, further comprising
a second sensor unit that obtains the second data,
wherein the second sensor unit is provided in a roadside unit (RSU) installed near a road.

3. The information processing system according to claim 1,
wherein the comparison unit is provided in a roadside unit (RSU) installed near a road,
the comparison unit configured to calculate a magnitude of a deviation between the first data and the second data.

4. The information processing system according to claim 1,
wherein the comparison unit
compares the first data and the second data obtained at a same time.

5. The information processing system according to claim 1,
wherein the correction information generation unit is provided in a roadside unit (RSU) installed near a road, and
the correction information generation unit does not generate the correction data for the plurality of vehicles when a magnitude of deviation between the first data and the second data acquired from a plurality of vehicles calculated by the comparison unit is all larger than a predetermined value.

6. The information processing system according to claim 1,
wherein the first acquisition unit applies the correction data transmitted by the transmission unit to the first sensor unit and thereafter acquires the first data obtained by the first sensor unit,
the information processing system further comprises an application determination unit that determines applicability of the correction data to the vehicle based on a comparison result of the comparison unit, and
the transmission unit is provided in a roadside unit (RSU) installed near a road, the transmission unit configured to transmit a determination result of the application determination unit to the vehicle.

7. The information processing system according to claim 6,
wherein, in a case where the application determination unit has determined that the correction data is not applicable to the vehicle,
the transmission unit transmits information to restrict use of the first sensor unit, to the vehicle.

8. The information processing system according to claim 1, further comprising
a sensor information correction unit that applies the correction data to the first sensor unit,
wherein the sensor information correction unit is provided in the vehicle.

9. The information processing system according to claim 1, further comprising
a function restriction processing unit that restricts use of the first sensor unit based on information to restrict the use of the first sensor unit,
wherein the function restriction processing unit is provided in the vehicle.

10. The information processing system according to claim 1,
wherein an acquisition time of the first data and an acquisition time of the second data are synchronized with each other by a time obtained from a GPS receiver.

11. The information processing system according to claim 1,
wherein the information processing system
acquires the first data and the second data in a predetermined region of a road.

12. The information processing system according to claim 1,
wherein the object is a marker installed on a road, and
the first data and the second data represent a distance between the vehicle and the marker.

13. The information processing system according to claim 2,
wherein the information processing system further comprises a server device communicably connected to the roadside unit (RSU), and
the server device includes the first acquisition unit, the second acquisition unit, the comparison unit, the correction information generation unit, and the transmission unit.

14. An information processing method comprising:
a first acquisition step of acquiring first data related to a positional relationship between a vehicle and an object existing around the vehicle, the first data being obtained by a first sensor unit that is mounted on the vehicle and obtains information related to travel control of the vehicle, the first data being obtained together with a time at which the first data is obtained;
a second acquisition step of acquiring second data related to a positional relationship regarding objects existing on a road together with a time at which the second data is obtained;
a comparison step of comparing the first data and the second data based on the time of individual acquisition of the first data and the second data;
a correction information generation step of generating correction data to be used for correcting an output of the first sensor unit based on a comparison result of the comparison step; and
a transmission step of transmitting the correction data to the vehicle.

15. An information processing apparatus comprising:
a first acquisition unit that acquires first data related to a positional relationship between a vehicle and an object existing around the vehicle, the first data being obtained by a first sensor unit that is mounted on the vehicle and obtains information related to travel control of the vehicle, the first data being obtained together with a time at which the first data is obtained;
a second acquisition unit that acquires second data related to a positional relationship regarding objects existing on a road together with a time at which the second data is obtained;
a comparison unit that compares the first data and the second data based on the time of individual acquisition of the first data and the second data;
a correction information generation unit that generates correction data to be used for correcting an output of the first sensor unit based on a comparison result of the comparison unit; and
a transmission unit that transmits the correction data to the vehicle.
